(19) United States
(12) Patent Application Publication
(10) Pub. No.: US 2011/0304255 A1
(43) Pub. Date: Dec. 15, 2011

(54) Extended-life Lamp With Integral Cooling

(76) Inventors: Jack Verne Miller, Seaford, DE (US); Ruth Ellen Miller, Seaford, DE (US)

(21) Appl. No.: 12/797,769

(22) Filed: Jun. 10, 2010

(51) Int. Cl. H01J 7/24

(52) U.S. Cl. 313/45

(57) ABSTRACT

An extended-life lamp with integral cooling includes a circular central body having a proximal end terminating in a male screw base and a distal end having a light source. A pair of electrical conductors from the male screw base pass through an electrically-insulating, heat-conducting matrix within the central body to the electrodes of the light source. Heat generated by the light source and electrodes, as well as any heat generated by power-conditioning components, such as a fluorescent ballast or an incandescent low-voltage transformer, is conducted through the matrix to a circular heat-conductive, heat-emissive radiator, thermally bonded to the central body and emitting lamp heat from the cooling fins.

U.S. patent references Cited:
5,099,399—Miller, et al
5,263,874—Miller, et al
4,178,535—Miller, et al
D-267,978—Miller, et al
Ser. No. 11/881,787—Miller
Ser. No. 12/794,063—Miller
Ser. No. 11/986,648—Miller

### FIELD OF THE INVENTION

The present invention relates to the field of single-circuit and 3-way lamps used in recessed lighting fixtures for general lighting in residential, institutional and commercial buildings, and includes both T/H/(Tungsten/Halogen) lamps and CFL (Compact Fluorescent Lamps).

### BACKGROUND OF THE INVENTION

Over recent years here has been an ever-increasing need for energy conservation in general lighting for residential, institutional and commercial buildings. One of the means for saving lighting energy has been the replacement of relatively inefficient A-type incandescent lamps with tungsten/halogen lamps having about twice the L/P (lumens per Watt) or with CFL (Compact Fluorescent Lamps) having three times the L/W of common incandescent lamps. A recent entry into the market is a 3-way spiral-tube CFL that permits the user to use lower lumen outputs (and less energy) for fixtures in selected areas. Further, pending application Ser. No. 11/986,648 filed by the applicant of the present invention provides a tungsten/halogen 3-way lamp. Three-way lamp operation permits selection of light levels (and thus energy-use) that matches the occupancy and visual task requirements for in the interest of energy conservation.

It is the practice in the lighting industry to quote the expected operating life on a lamp, based on laboratory temperature conditions, and wherein the published life of the lamp is the point at which half of the lamps in an installation have failed. The applicants have found that nearly every lamp failure is due to leakage through the glass-to-metal seals of the lamp electrodes. This is true for both tungsten/halogen and compact fluorescent lamps.

Lamp seal leakage is caused by the differential expansion between the metal electrodes and the surrounding glass lamp envelope. Recognition of his fact led to the design of the cooling fins on the T/H lamp bi-pin socket of U.S. Pat. No. 5,263,874, used in the fiber optic projectors of applicant's U.S. Pat. No. 5,099,399. Thus the cooling fins on the lamp socket in the air flow of the fan in the '399 patent cools the lamp seals, and in practice has been shown to double the operating life of the lamps. This clearly shows a long-felt need for the present invention applied to Tungsten/Halogen lamps.

The failures of CFLs are more complex. These lamps have the same differential expansion failure mode as the T/H lamps, so they can benefit from cooling like the T/H lamps. However, the CFLs have integral ballast(s) that fail more quickly at high temperatures. Thus it is necessary to cool both the amp electrodes and the ballast to extend lamp life. Ballast cooling was employed in the applicant's U.S. Pat. No. 4,178,535, with air flow through the ballast vents seen in the applicant's Pat. D-267,978. Since the electrodes are hotter than the ballast, heat flows from the electrodes to the ballasts in a CFL. This problem is severe enough that CFLs are labeled “Not for use in enclosed light fixtures”. This clearly shows the long-felt need for the present invention for Compact Fluorescent lamps. Thus the present invention will permit the design of enclosed, recessed light fixtures to meet the requirements of UL standard 1598 for recessed luminaires.

### BRIEF DESCRIPTION OF THE DRAWINGS

FIG. 1 is a side elevation view of an extended-life CFL (Compact Fluorescent Lamp) according to the present invention.

FIG. 2 is transverse plan view of the proximal (screw-base) end of the lamp of FIG. 1;

FIG. 3 is cross-sectional view of the invention taken along Section line A-A of FIG. 1; and

FIG. 4 is transverse cross-sectional view of the invention taken along Section line B-B of FIG. 3.

FIG. 5 is a side elevation view of an extended-life T/H (Tungsten/Halogen) lamp according to the present invention.

FIG. 6 is transverse plan view of the proximal (screw-base) end of the lamp of FIG. 5;

FIG. 7 is cross-sectional view of the invention taken along Section line C-C of FIG. 5; and

FIG. 8 is transverse cross-sectional view of the invention taken along Section line D-D of FIG. 7.

### DETAILED DESCRIPTION OF THE DRAWINGS

In FIG. 1 the side elevation view of an extended-life CFL (Compact Fluorescent Lamp) according to the present invention (1) is shown having a CFL (2) including a spiral fluorescent tube (3) having electrodes (4,4a) terminating in a generally-circular housing shell (6) normally made of a temperature-resistant plastic, such as polycarbonate, and enclosing a fluorescent ballast (18). Housing shell (6) terminates in a screw base (22) at a proximal end (8) on an optical axis (15), and is disposed within a circular heat radiator (7) made of thermally-conductive and heat-emissive metal, such as black-anodized aluminum.

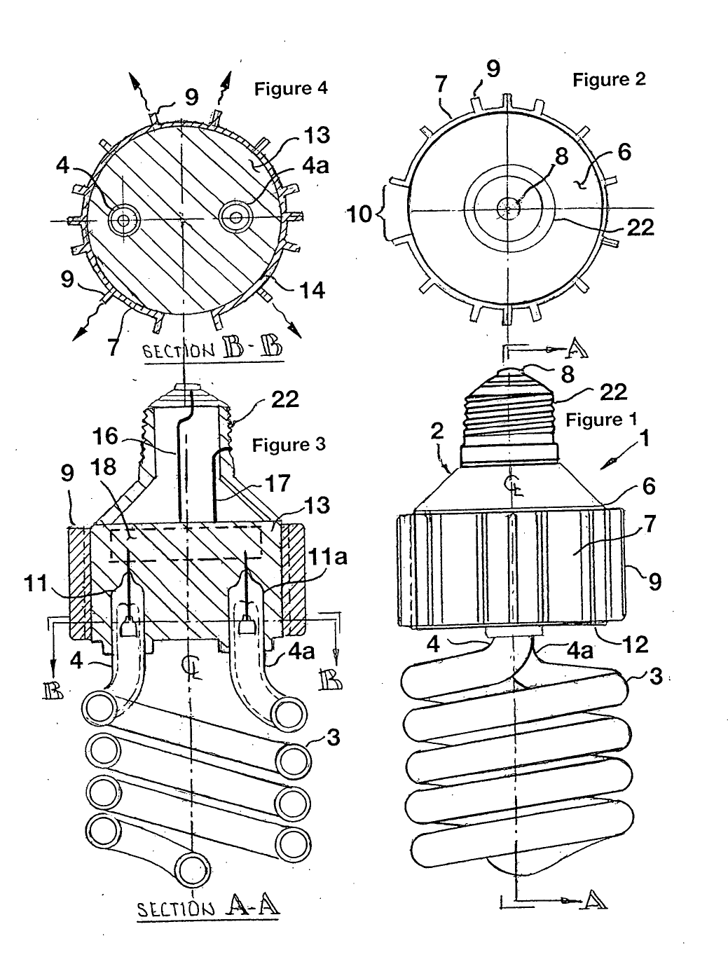

In FIG. 2, a transverse plan view is shown in which the CFL (2) is held within the heat radiator (7) having a number of radial fins (9). Heat radiator (7) has an inside diameter smaller than the housing shell (6) and has a gap (10) therein that permits the radiator (7) to be resiliently engaged onto the housing shell (6).

In FIG. 3 a cross-section view A-A of FIG. 1 is shown including the generally circular housing shell (6) disposed within the radiator (7). Electrodes (4,4a) terminate in glass-to-metal seals (11,11a) that are encapsulated, along with a fluorescent ballast (18), in an electrically insulative, heat-conductive matrix (13). The heat-conductive matrix (13) conducts electrode and ballast heat to the radiator (7), to be emitted from the thermally-emissive fins (9).

In FIG. 4, a cross section view B-B of FIG. 3 is shown with housing shell (6) held within the heat radiator (7) and bonded therein with a heat-conducting adhesive, such as aluminum-filled epoxy (14). Then the heat-conductive matrix (13) conducts the electrode and ballast heat to the radiator (7), to be emitted from the thermally-emissive fins (9).

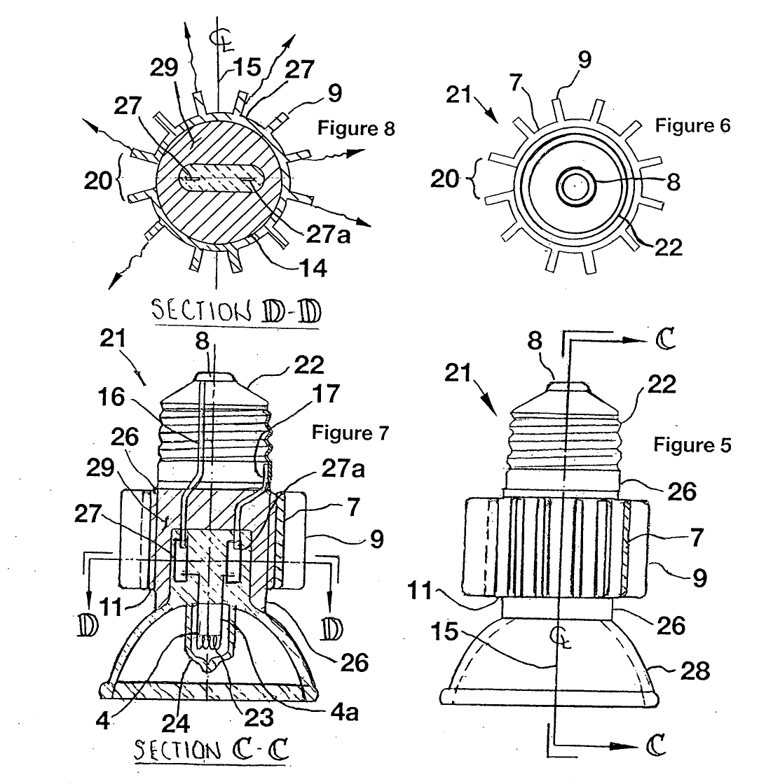

In FIG. 5 the side elevation view of an extended-life T/H (Tungsten/Halogen) incandescent lamp (21) according to the invention is shown in the form of an “MR” (Miniature Reflector) lamp (21) having screw shell (22) at a proximal end (8) and a reflector (27) disposed on an optical axis (CL) at the distal end. A central housing shell (26) is disposed within a circular heat radiator (7) having heat-emitting fins (9). The radiator (7 is made of thermally-conductive and heat-emissive metal, such as black-anodized aluminum. A generally-circular housing shell (26), made of a heat-conducting material, such as a ceramic, is disposed on an optical axis (15) within the heat radiator (7).

In FIG. 6, a transverse plan view is shown in which the T/H lamp (21) is held within the heat radiator (7) having a number of radial fins (9). Heat radiator (7) has an inside diameter smaller than the housing shell (26) and has a gap (20) therein that permits the radiator (7) to be resiliently engaged onto the housing shell (26).

In FIG. 7 a longitudinal cross-section view A-A of FIG. 5 is shown including a generally circular housing shell (26) disposed within the radiator (7). Electrodes (4,4a) terminate in glass-to-metal foil seals (27,27a) that are encapsulated, along with power conductors (16,17) from screw shell (22), in a heat-conductive matrix (33) that conducts electrode heat to the radiator (7), to be radiated from emissive fins (9). The lamp filament 23 and filament leads (4,4a) are enclosed in a gas-tight tubular quartz envelope (24).

In FIG. 8, a transverse cross section view D-D of FIG. 7 is shown in which the housing shell (6) is held within the heat radiator (7) and bonded therein with a heat-conducting adhesive, such as aluminum-filled epoxy (14). Then the heat-conductive matrix (33) conducts electrode heat to the radiator (7), to be emitted from the thermally-emissive fins (9). The applicants' prior art U.S. Pat. No. 5,263,874 provides cooling radiators on the lamp socket, instead of the lamp itself in the present invention. This demonstrates the principle of lamp life extension by cooling the electrodes, but bonding the radiator directly to the lamp in the present invention instead of the lampholder of the '874 patent provides better electrode cooling, less differential expansion, and thus more lamp life.

### SUMMARY OF THE INVENTION

The stated purposes of the present invention are achieved by the present invention, increasing lamp life by providing either T/H (Tungsten/Halogen) or CFL (Compact Fluorescent) lamps that include radiators reducing the glass-to-metal seal temperatures. Thereby reducing the differential expansion between the glass and the metal conductors and significantly extending the operating life of the lamps. In addition, the invention reduces the CFL ballast temperature, extending the service life and allowing CFL lamps to be used reliably in recessed light fixtures.

LIST OF ELEMENTS

| | |
|---|---|
| 1. CFL lamp invention | 2. Compact fluorescent lamp |
| 3. spiral fluorescent tube | 4. First CFL electrode |
| 4a. second CFL electrode | 5. Not used |
| 5. first T/H electrode | 5a. second T/H electrode |
| 6. CFL housing shell | 7. heat radiator |
| 8. Proximal end contact | 9. cooling fins |
| 10. gap in CFL radiator | 11. first CFL glass-to-mtal seal |
| 11a. Second CFL glass-to-metal seal | 12. distal end, CFL housing shell |
| 13. CFL matrix material | 14. heat conductive adhesive |
| 15. Optical centerline | 16. T/H center conductor wire |
| 17. T/H Screw shell wire | 18. CFL ballast |
| 19. Not used | 20. gap in T/H lamp radiator |
| 21. T/H lamp invention | 22. lamp base screw shell |
| 23. T/H lamp filament | 24. T/H lamp glass envelope |
| 25. not used | 26. T/H housing shell |
| 27. first T/H foil strip | 27a. second T/H foil strip |
| conductor | conductor. |
| 28. T/H lamp reflector | 29. T/H matrix material |

1. An extended-life lamp (1) with integral cooling including:
a generally circular central body (6) on an optical axis (15), said central body having a proximal end (8) having a male screw base (22) and a distal end (12) having a light source (3) connected from a pair of electrodes (4,4a) and electrical conductors (16,17) through an electrically-insulating, heat-conducting matrix (13) within said central body from said screw base (22); and
a generally circular heat-conductive and heat-emissive radiator (7) thermally bonded to said central body (6) and emitting heat therefrom.

2. An extended-life lamp (1) with integral cooling according to claim 1 in which the light source (3) is a compact fluorescent lamp tube terminating its ends at electrodes (4,4a) which are connected through sealed conductors (11,11a) to a fluorescent ballast (18) within said matrix (13), which in turn is connected through said electrical conductors (16,17) passing through said matrix (13) to said screw base (22), and wherein heat emitted from said electrodes (4,4a) and fluorescent ballast (18) is conducted through said matrix (13), said central body (6), and to be emitted from said radiator (7).

3. An extended-life lamp (1) with integral cooling according to claim 1 in which the generally-circular radiator (7) has a gap (10) therein, and an inside diameter smaller than the outside diameter of the central body (6), whereby the gap (10) is spread apart for resilient contact with central body (6) and bonded to said central body (6) with heat conducting adhesive (14), and wherein said radiator (7) has a number of heat-radiating fins (9) externally radiating heat from said electrodes (4,4a) and said fluorescent ballast (18).

4. An extended-life lamp (21) with integral cooling according to claim 1 in which the light source is a tungsten/halogen lamp with a filament (23) terminating its ends at electrodes (4,4a) within said matrix (29), said filament (23) being connected through said electrical conductors (16,17) through said matrix (13) from said screw base (22), and wherein heat emitted from said electrodes (4,4a) is conducted through said matrix (13), within said central body (6) to said radiator (7) externally emitting lamp heat from fins (9).

5. An extended-life lamp (21) with integral cooling according to claim 1 in which the tungsten/halogen lamp filament (23) is enclosed and sealed within a gas-tight envelope (24).

6. An extended-life lamp (1) with integral cooling according to claim 1 in which the generally-circular radiator (7) of the tungsten/halogen lamp has a gap (20) therein, and an inside diameter smaller than the outside diameter of the central body (26), whereby the gap (10) is spread apart for resilient contact with central body (26) and is bonded to said central body (26) with a heat conducting adhesive (14).
